(19) United States
(12) Patent Application Publication
(10) Pub. No.: US 2013/0013495 A1
(43) Pub. Date: Jan. 10, 2013

(54) TRANSACTION INFORMATION ROUTING

(75) Inventors: Joseph A. Giordano, Waxhaw, NC (US); Elbert L. Whitler, Webster Groves, MO (US); Herbert M. Fellman, Charlotte, NC (US)

(73) Assignee: Bank of America, Charlotte, NC (US)

(21) Appl. No.: 13/616,519

(22) Filed: Sep. 14, 2012

Related U.S. Application Data
(63) Continuation of application No. 12/732,324, filed on Mar. 26, 2010.

(51) Int. Cl. G06Q 40/00

(52) U.S. Cl. 705/39

(57) ABSTRACT

Apparatus and methods for routing transaction information. The apparatus and methods may involve using receiving the transaction information; retrieving from computer readable memory: (a) a transaction information routing rule; and (b) transaction service provider information; and formulating routing information based on the transaction information, the transaction service provider information and the routing rule. The apparatus and methods may identify prospective recipients, among participants in a transaction, for receipt of the transaction information.

### FIELD OF TECHNOLOGY

Aspects of the disclosure relate to providing apparatus and methods for routing information relating to a transaction. In particular, the disclosure relates to apparatus and methods for routing information between financial institutions in connection with a transaction between a customer and a vendor.

### BACKGROUND

In a typical credit card transaction, a customer (the “customer”) purchases from a merchant or service provider (“the merchant”) goods or services (“the goods”) using credit. The credit is extended to the customer by an issuing bank (the “issuer”). The merchant presents a debit to an acquiring bank (the “acquirer”). The acquirer pays the merchant for (and thus “acquires”) the goods. A transaction processing network in communication with the issuer and the acquirer settles the transaction between the issuer and the acquirer. The transaction processing network may collect transaction processing network fees from the issuer and the acquirer in connection with the settlement.

The issuer may impose upon the acquirer a fee for participating in the transaction. The fee may be referred to as “interchange.” Interchange may be a fixed fee for the transaction or a percentage of the transaction. Interchange flows from the acquirer, through the transaction processing network, to the issuer. The issuer typically uses interchange to cover costs of acquiring credit card customers, servicing credit card accounts, providing incentives to retain customers, mitigating fraud, covering customer credit risk, group comp and other expenses.

The acquirer may deduct a “transaction fee” from the amount that the acquirer pays the merchant in exchange for the goods. The transaction fee may cover the acquirer's transaction processing network fee, interchange, and other expenses. The acquirer may obtain a profit from the transaction fee.

FIG. 1 shows typical credit card transaction settlement flow 100. Flow 100 involves transaction participants such as a merchant, a customer, and transaction service providers that are identified below. At step 1, the merchant provides transaction information related to a proposed transaction between the merchant and a customer to a transaction authorization and clearance provider. The transaction authorization and clearance provider may provide transaction authorization and clearance information to the merchant. The transaction authorization and clearance information may include authorization for the transaction to proceed. At step 2, the merchant provides $100 in goods to a customer. The customer pays with a credit card. At step 3, the issuer transmits to the customer a statement showing the purchase price ($100.00) due. The issuer collects the purchase price amount, along with interest and fees if appropriate, from the customer. At step 4, the issuer routes the purchase price amount ($100.00) through the transaction processing network to the acquirer. At step 5, the acquirer partially reimburses the merchant for the purchase price amount. In the example shown in FIG. 1, the partial reimbursement is $98.00. The difference between the reimbursement amount ($98.00) and the purchase price amount ($100.00) is a two dollar ($2.00) transaction fee.

At step 6, the acquirer pays an interchange amount ($1.50), via the transaction processing network, to the issuer. At step 7, both the acquirer and the issuer pay a transaction processing network fee ($0.07 for acquirer and $0.05 for the issuer) to the transaction processing network.

TABLE 1
Net positions, by participant, based on settlement
flow 100 (shown in FIG. 1).

| Participant | Net ($) |
|---|---|
| Issuer | 1.45 |
| Acquirer | 0.43 |
| Transaction processing network | 0.12 |
| Merchant | −2.00 |

In settlement 100 (shown in FIG. 1), the transaction fee is based on a merchant discount rate of 2%. The $1.50 interchange is based on an interchange rate of 1.5%. The sum of the transaction processing network fees ($0.07 and $0.05) is based on a total transaction processing network fee rate of 12%.

Transaction processing networks and transaction processing network services offered under the trademarks VISA, MASTERCARD, NYCE and PULSE are known. Transaction processing networks typically set interchange rates. Interchange rates often depend for each transaction processing network on merchant type and size, transaction processing method and other factors. Some transaction processing networks set rules that prohibit merchants from charging an incremental fee for credit card payments, establishing minimum or maximum purchase price amounts or refusing to accept selected cards.

The flow of transaction information between the transaction service providers is typically circumscribed by the relationships that are illustrated in FIG. 1. When relationships other than those shown in FIG. 1 are available, the other relationships may provide pathways for routing transaction information that may be used to execute one or more of the steps of a transaction between the merchant and the customer.

It would be desirable, therefore, to provide apparatus and methods for routing transaction information between transaction service providers.

### SUMMARY OF THE INVENTION

Apparatus and methods for routing transaction information are provided. The apparatus and methods may involve a receiver module configured to receive the transaction information and computer readable memory configured to store (1) a transaction information routing rule; and (2) transaction service provider information. The apparatus and methods may involve a processor module configured to output transaction information routing information based on the transaction information, the transaction service provider information and the routing rule.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art scenario;

FIG. 2 shows apparatus in accordance with the principles of the invention;

FIG. 3 shows apparatus and information in accordance with the principles of the invention;

FIG. 4 shows an arrangement in which apparatus and methods in accordance with the principles of the invention may be used;

FIG. 5 shows another arrangement in which apparatus and methods in accordance with the principles of the invention may be used;

FIG. 6 shows yet another arrangement in which apparatus and methods in accordance with the principles of the invention may be used;

FIG. 7 shows steps of a process in accordance with the principles of the invention.

### DETAILED DESCRIPTION OF THE INVENTION

Apparatus and methods for providing transaction information routing are provided. The apparatus and methods may involve a receiver module configured to receive the transaction information and computer readable memory configured to store (1) a transaction information routing rule; and (2) transaction service provider information. The apparatus and methods may also involve a processor module configured to output transaction information routing information based on the transaction information, the transaction service provider information and the routing rule.

The transaction information may include any information that is communicated, or would be appropriate to communicate, from one transaction participant to another transaction participant in connection with a transaction between a merchant and a customer. Table 1 shows illustrative transaction participant types.

TABLE 1
Illustrative transaction participant types.
Illustrative Transaction Participant Types

Merchant
Customer
Authorization service
Clearance service
Issuer
Network
Acquirer

More than one participant of a given type may be available to participate in a transaction. Different participants of the same type may have advantages and/or disadvantages relative to the other participants of that type. For example, one issuer may be a member of a lending consortium while another is not a member, one network may require payment a small interchange fee while another network requires payment of a large interchange fee, and the like.

The transaction routing rule may require that the transaction information be communicated from a first transaction participant to a second transaction participant. The rule may identify the second transaction participant. The rule may identify uniquely the second participant. The rule may require that the second participant be a member of an identified group. The rule may require that the second participant satisfy one or more criteria. The rule may require that the second participant satisfy one or more conditions. The rule may provide priorities with respect to the criteria or conditions.

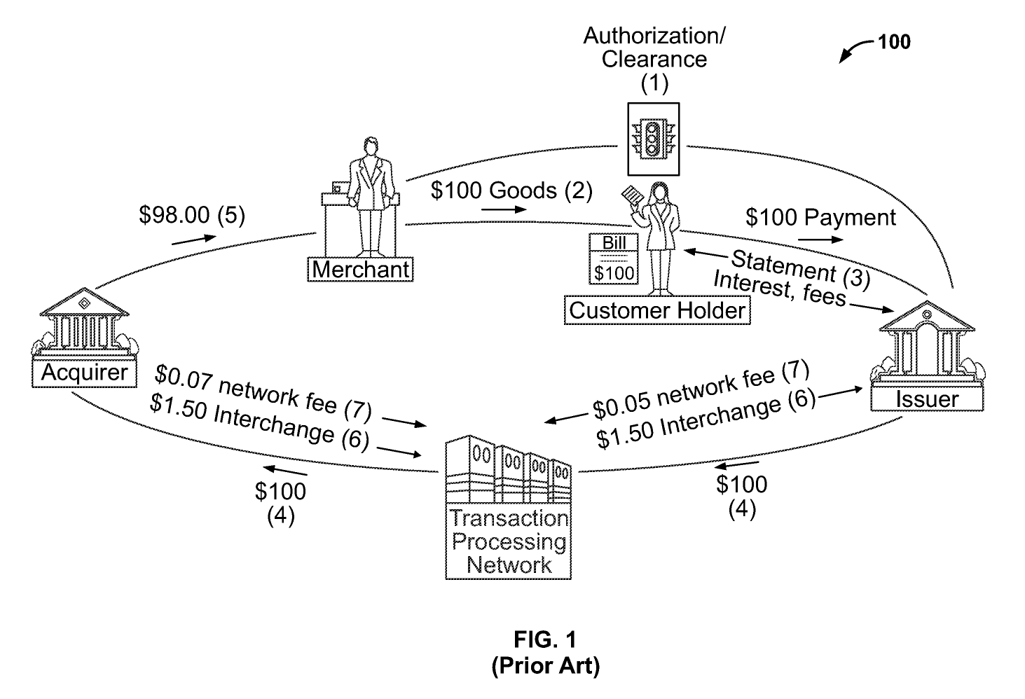

The transaction routing rule may require that one or more transaction services be performed in connection with the transaction. For example, the transaction routing rule may require that one or more of the illustrative transaction services (and associated activities) shown in FIG. 1 or listed in Table 2 be performed.

TABLE 2
Illustrative transaction services.
Illustrative Transaction Service

Sale of goods to customer
Authorization of customer credit
Clearance of customer credit
Notice of customer balance
Invoice of customer for bank service
Invoice of network fee
Invoice of interchange fee
Matching of acquirer and issuer
Acquisition of goods

Each of the transaction services may be performed by a transaction participant. In some circumstances, a participant may perform more than one of the services. Each participant may charge a fee for providing the service. The fee may be charged to one or more of the other participants (as shown in FIG. 1). Thus, for each transaction, a participant may be required to pay (or collect), in sum, a “net” fee. The rule may require that the net fee for a designated participant conform to a requirement. For example, the rule may require that the participants be chosen such that the customer is assessed a minimum fee based on the transaction services to be provided.

Table 3 shows illustrative conditions and corresponding rules. Conditions and rules may include a preference for one or more participant. For example, a minimum net fee rule may prefer an acquirer. In such a rule, the transaction information would be required to be routed to participants such that the acquirer's net fee is minimized.

TABLE 3
Illustrative conditions and corresponding
transaction information routing rules.

| Illustrative Condition | Illustrative Rule |
|---|---|
| Acquirer-preferred | |
| Acquirer = Issuer (“ON US”) | Route transaction information |
| | internally to an issuing function. |
| Acquirer and Issuer are members | Route transaction information |
| of a lending consortium (“ON | directly to Issuer. |
| WE”) | |
| Network “X” provides lowest | Route transaction to network X. |
| interchange fee, greatest | |
| reliability (e.g., lowest | |
| occurrence of chargeback or | |
| exceptions) or highest | |
| incentives to acquirer | |
| Issuer-preferred | |
| Customer has selected form | Select authorization service and |
| (e.g., credit card, debit card | route transaction information to |
| and the like) | same. |
| | Select clearance service and route |
| | transaction information to same. |
| | Select settlement service and route |
| | transaction information to same. |
| | Suggest to customer a different |
| | payment type based on advantage to |
| | issuer (e.g., highest net revenue to |
| | issuer based on available routing |
| | options). |
| Issuer = Acquirer (“ON US”) | Route transaction information |
| | internally to internal acquiring |
| | function. |
| Issuer and Acquirer are members | Route transaction information |
| of a lending consortium (“ON | directly to acquirer. |
| WE”) | |
| Merchant-preferred | |
| Acquirer “Y” offers lowest | Route transaction information to |
| acceptance costs | acquirer Y for acquisition from |
| | merchant. |
| Customer-preferred | |
| Purchase instrument “Z” offers | Provide customer with opportunity to |
| smallest fees to customer or | utilize purchase instrument Z and |
| greatest incentives | route transaction information to |
| | offeror or processor of purchase |
| | instrument Z. |

In some embodiments, the rule may be conditioned on a purchasing instrument that the customer selects for executing the transaction. The purchasing instrument may be a credit card, a debit card, an instrument or device that includes a contactless chip, such as an ISO14443-compliant contactless chip, a cell phone, a personal data assistant or any other suitable electronic purchasing devices. Purchasing instruments may store data in a magnetic strip, a bar code, a silicon chip or any other suitable data storage device or format. The merchant may provide a POS terminal that is configured to receive data from, provide data to, or exchange data with the purchasing instrument.

The customer may select a card that is associated with an issuer. The customer may select a signature-based transaction. The customer may select a PIN-based transaction. The selections may fulfill conditions necessary for application of the rule. The selections may not fulfill conditions necessary for application of the rule.

In some embodiments, the rule may be conditioned on information about the customer's credit or purchasing behavior. For example, the rule may require routing the transaction history in a manner that attenuates risk if the customer has a poor credit history.

The rules may be provided by a one or more of the participants. The rules may be updated and/or revised.

The transaction service provider information may include transaction service provider identification information. The transaction service provider information may include a transaction service provider attribute. The attribute may relate to group membership, transaction service features and any other suitable transaction service provider information. The attribute may be a condition for the transaction routing rule.

The transaction information routing information may identify one or more second participants to whom the transaction information should be directly or indirectly routed in order to satisfy one or more transaction rules. For example, the routing information may identify an individual second participant, a group of second participants, a list of one or more prospective second participants and the like. The routing information may include a routing table. The routing table may include a list of participants. Each of the participants on the list may correspond to a transaction service that is provided by one or more of the participants identified in FIG. 1 or Table 1. In some embodiments, the table may include more than one list. When more than one list is included, one or more of the lists may be prioritized with respect to one or more of the other lists. In some embodiments, when more than one list is included, one or more of the lists may be conditioned upon an outcome of a routing that is based on one or more of the other lists.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

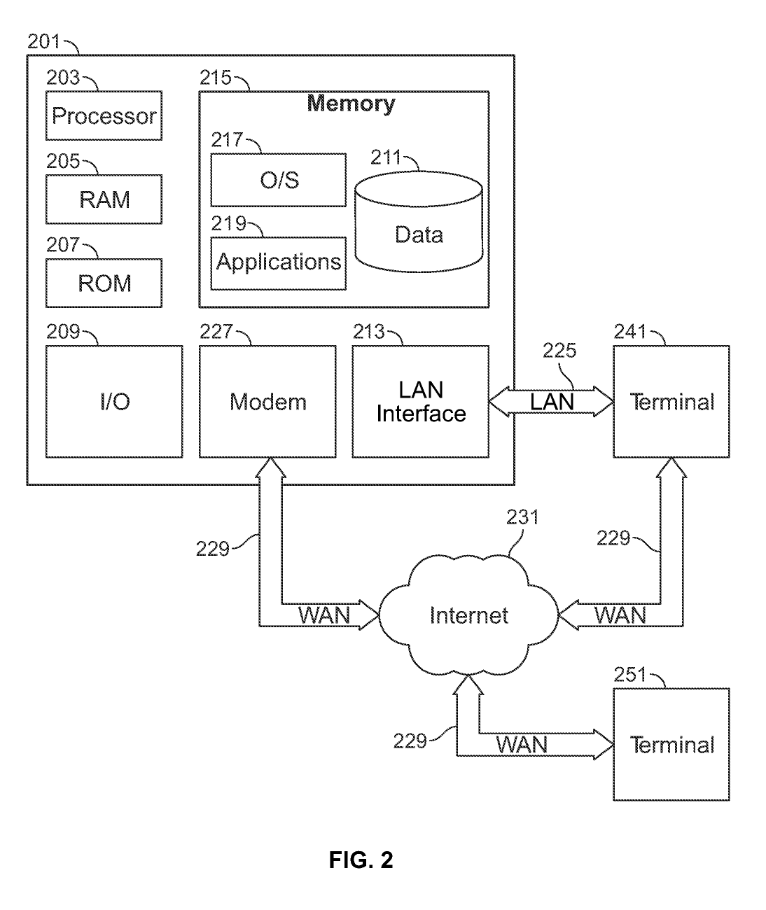

FIG. 2 is a block diagram that illustrates a generic computing device 201 (alternatively referred to herein as a “server”) that may be used according to an illustrative embodiment of the invention. The computer server 201 may have a processor 203 for controlling overall operation of the server and its associated components, including RAM 205, ROM 207, input/output module 209, and memory 225. Server 201 may include one or more receiver modules, server modules and processors that may be configured to receive transaction information, receive transaction information routing rules, receive transaction participant information, receive transaction service provider information, apply transaction information routing rules, generate transaction information routing information and perform any other suitable tasks related to routing transaction information.

Input/output (“I/O”) module 209 may include a microphone, keypad, touch screen, and/or stylus through which a user of device 201 may provide input, and may also include one or more of a speaker for providing audio output and a video display device for providing textual, audiovisual and/or graphical output. Software may be stored within memory 225 and/or storage to provide instructions to processor 203 for enabling server 201 to perform various functions. For example, memory 225 may store software used by server 201, such as an operating system 217, application programs 219, and an associated database 221. Alternatively, some or all of server 201 computer executable instructions may be embodied in hardware or firmware (not shown). As described in detail below, database 221 may provide storage for customer information, transaction information, merchant information, transaction fee information, transaction fee factors and any other suitable information.

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 2 include a local area network (LAN) 225 and a wide area network (WAN) 229, but may also include other networks. When used in a LAN networking environment, computer 201 is connected to LAN 225 through a network interface or adapter 223. When used in a WAN networking environment, server 201 may include a modem 227 or other means for establishing communications over WAN 229, such as Internet 231. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (SMS), and voice input and speech recognition applications.

Computing device 201 and/or terminals 241 or 251 may also be mobile terminals including various other components, such as a battery, speaker, and antennas (not shown).

Terminal 251 and/or terminal 241 may be portable devices such as a laptop, cell phone, blackberry, or any other suitable device for storing, transmitting and/or transporting relevant information.

Any information described above in connection with database 221, and any other suitable information, may be stored in memory 225.

One or more of applications 219 may include one or more algorithms that may be used to receive transaction information, receive transaction information routing rules, receive transaction participant information, receive transaction service provider information, apply transaction information routing rules, generate transaction information routing information and perform any other suitable tasks related to routing transaction information.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

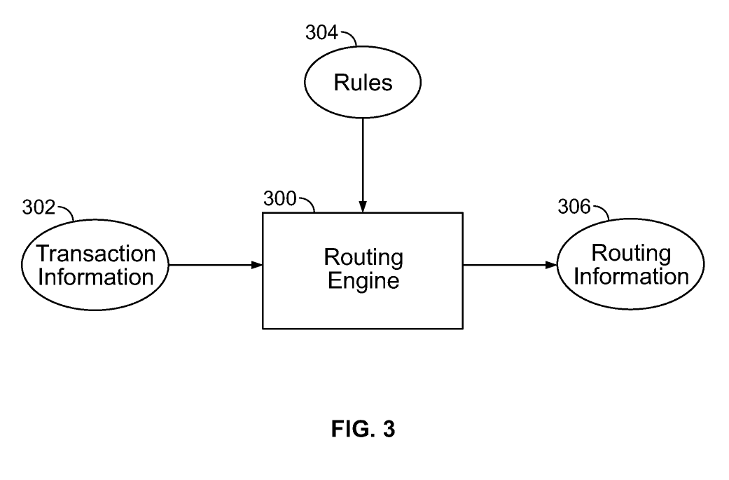

FIG. 3 shows illustrative routing engine 300. Illustrative routing engine 300 may include one or more of the devices or features shown in connection with server 201 (shown in FIG. 2). Routing engine 300 may receive transaction information 302 in connection with a transaction between a merchant and a customer. Routing engine 300 may apply rules 304 to transaction information 302 to generate routing information 306.

Transaction information 302 may include merchant identification information, customer identification information, purchasing instrument identification information, issuer information (e.g., a bank issuer number (“BIN”)), customer bank account information, transaction processing network identification information, transaction amount information and any other suitable information.

Rules 304 may be stored in a database and managed by a database engine.

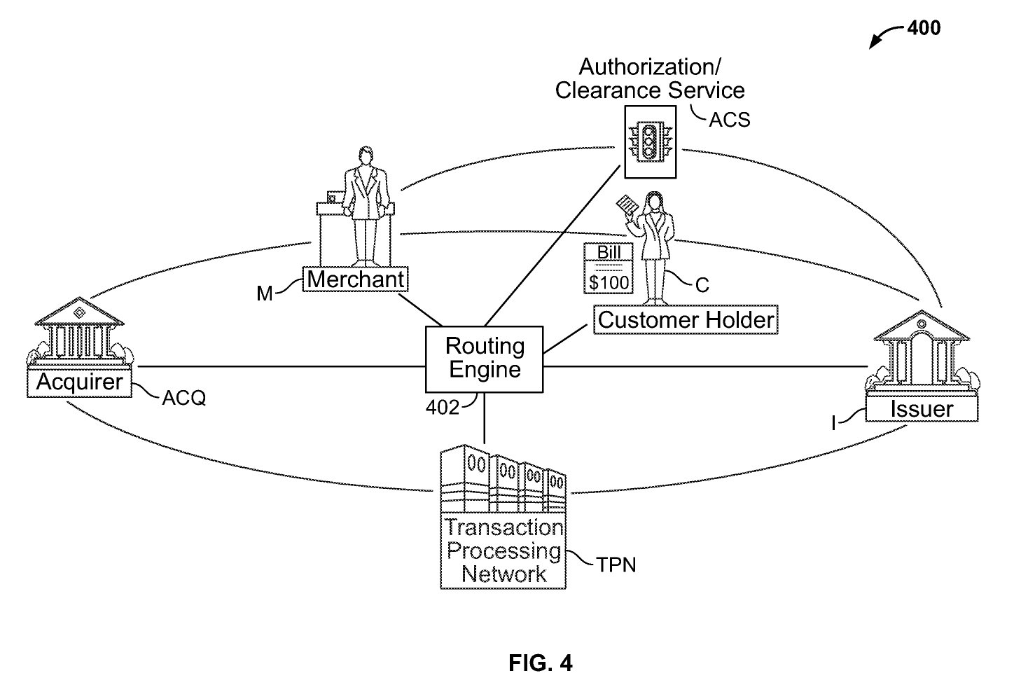

FIG. 4 shows illustrative routing topology 400. Routing engine 402, which may have some or all of the features of routing engine 300 (shown in FIG. 3), is in direct communication with participants such as: merchant M, authorization/clearance service ACS, customer C, issuer I, transaction processing network TPN and acquirer ACQ. Some or all of routing engine 402 and associated functions may be located with apparatus owned and/or controlled by one of the participants, in a location that is different from the participants' locations, or in any other suitable location. One or more of each participant type may be present in topology 400.

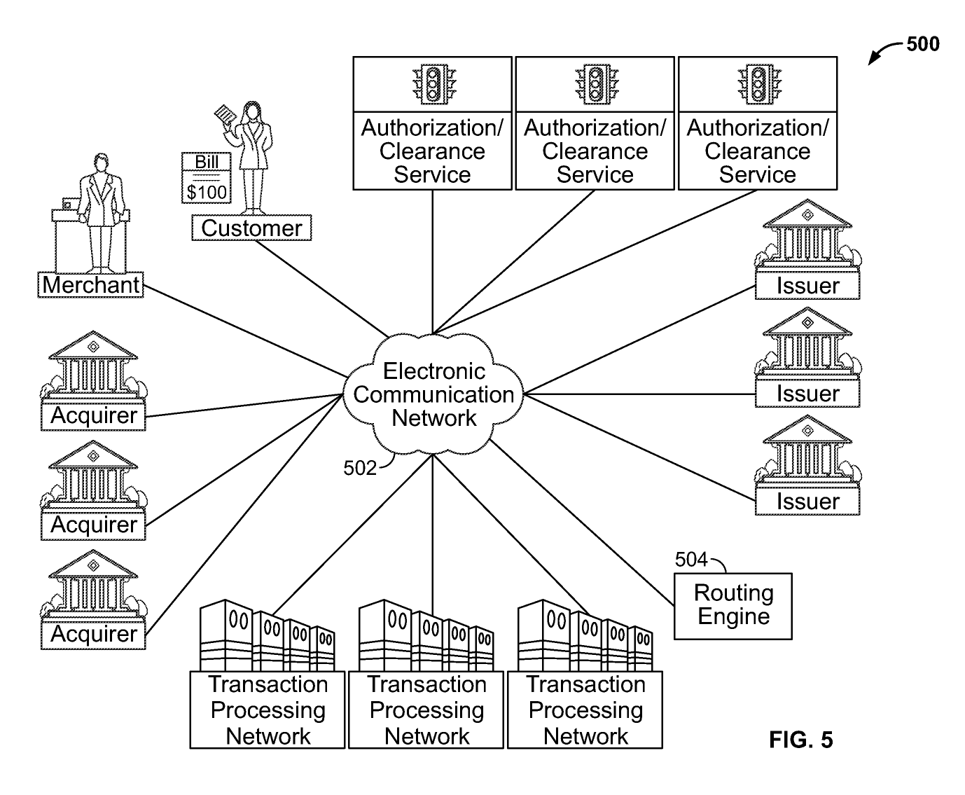

FIG. 5 shows illustrative routing topology 500. Illustrative routing topology 500 may operate in conjunction with electronic communication network 502. Electronic communication network 502 may have some or all of the features of Internet 231 (shown in FIG. 2). Routing engine 504, which may have some or all of the features of routing engine 300 (shown in FIG. 3), may manage the flow of transaction information between and among the transaction participants shown. Routing engine 504 may designate none, some or all of the shown participants of a given participant type to participate in the transaction. Routing engine 504 may thus select individual participants from within a participant type based on attributes of the individual participants. For example, different acquirers may require different acquisition fees, different transaction processing networks may require different interchange fees and different issuers may require different service charges.

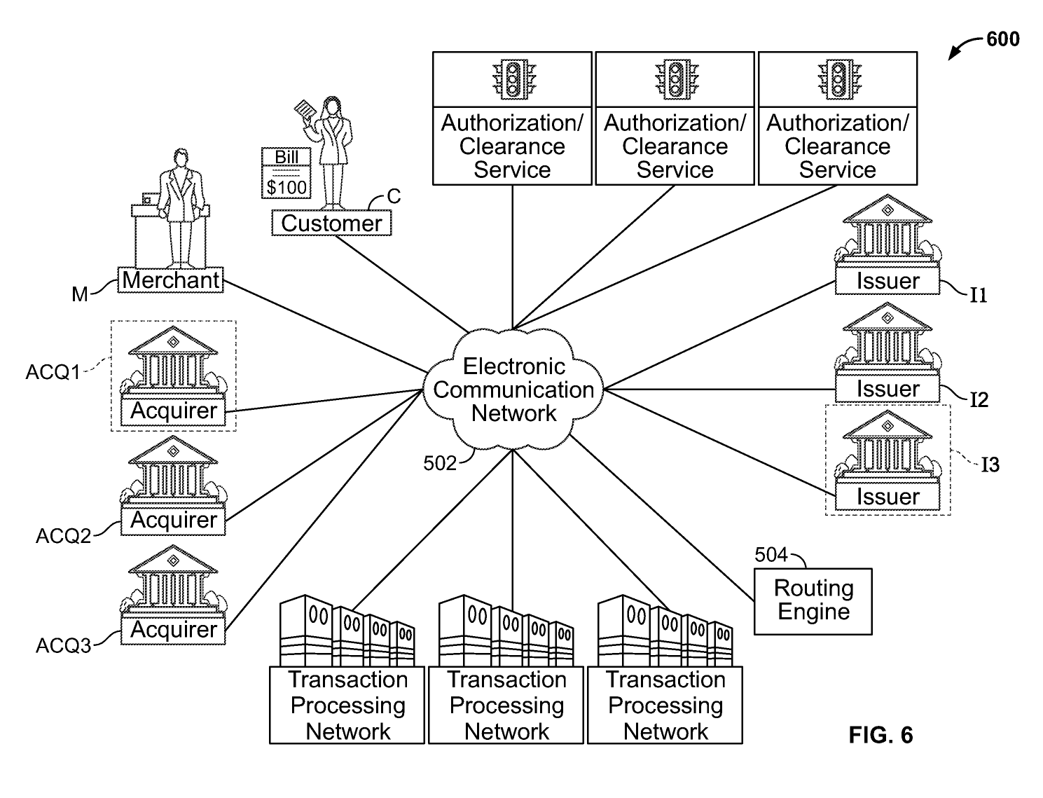

FIG. 6 shows illustrative scenario 600 in which routing engine 504 governs routing of transaction information between participants that include acquirers ACQ1, ACQ2, ACQ3 and issuers I1, I2 and I3. In scenario 600, ACQ1 and I3, which are both identified by a broken-line box, are members of a lending consortium. If, for example, customer C presented a purchasing instrument, such as a credit card, that was issued by issuer I3, routing engine 504 may route the transaction information directly to acquirer ACQ1 to execute the transaction. If, for example, acquirer ACQ1 does not have an acquisition relationship with merchant M, routing engine 504 may select a different acquirer with whom to execute the transaction. Routing engine 504 may be configured to select a different acquirer who is a member of the lending consortium. If no appropriate acquirer can be identified, routing engine 504 may query one of the transaction processing networks for an acquirer to complete the transaction.

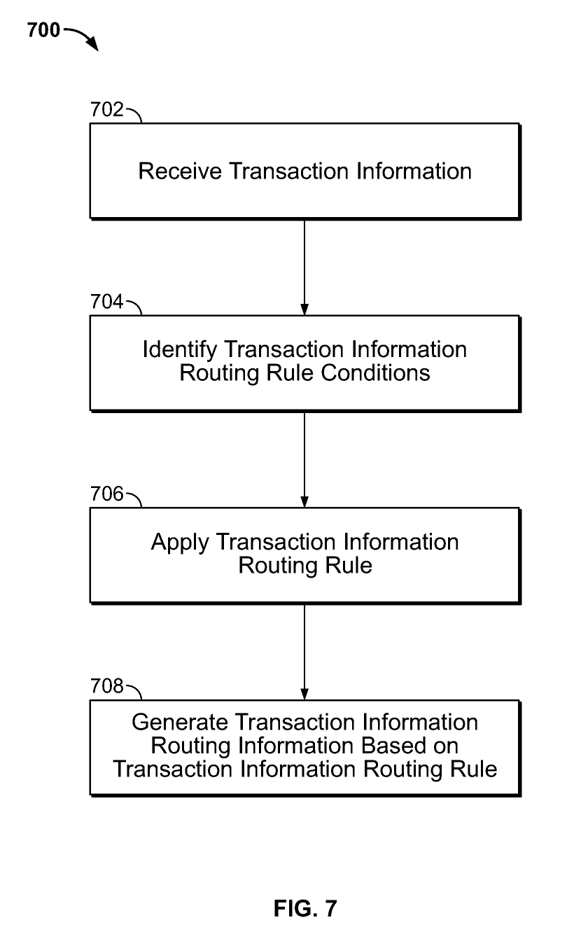

Processes in accordance with the principles of the invention may include one or more features of the process illustrated in FIG. 7. For the sake of illustration, the steps of the process illustrated in FIG. 7 will be described as being performed by a “system”. The “system” may include one or more of the features of the apparatus that are shown in FIG. 2 and/or any other suitable device or approach. The “system” may be provided by an entity. The entity may be an individual, an organization or any other suitable entity.

FIG. 7 shows illustrative process 700 for routing transaction information. Process 700 may begin at step 702. At step 702, the system may receive transaction information. For example, the system may receive transaction information from a transaction participant. At step 704, the system may identify one or more elements of the transaction information that trigger one or more routing rule conditions. At step 706, one or more routing rules may be identified based on the conditions. At step 708, the system may generate routing information based on the one or more rules. The transaction information may identify one or more other transaction participants to whom the information may be directly or indirectly routed.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for routing transaction information have been provided. Persons skilled in the art will appreciate that the present invention can be practiced by other than the described embodiments, which are presented for purposes of illustration rather than of limitation. The present invention is limited only by the claims that follow.

What is claimed is:

1. Apparatus for routing transaction information, the apparatus comprising:
a receiver module configured to receive the transaction information;
computer readable memory configured to store:
a transaction information routing rule; and
transaction service provider information;
a processor module configured to output routing information based on the transaction information, the transaction service provider information and the routing rule; and
if the transaction information routing rule does not identify an aquirer based on the transaction service provider information, a transmitter configured to transmit a query to a network requesting identification of an aquirer to complete the transaction.

2. The apparatus of claim 1 wherein the processor module is further configured to:
identify from the transaction service provider information that an acquirer is an issuer; and,
based on identification of the acquirer as an issuer, apply a routing rule that requires routing the transaction information within the acquirer from an acquiring function to an issuing function.

3. The apparatus of claim 1 wherein the processor module is further configured to:
identify from the transaction service provider information that an acquirer and an issuer are members of a lending consortium; and,
based on identification of the acquirer and issuer as members of the consortium, apply a routing rule that requires routing the transaction information from the acquirer to the issuer while bypassing a transaction processing network.

4. The apparatus of claim 1 wherein the first and second net fees are based at least in part on interchange fees.

5. The apparatus of claim 1 wherein the first and second net fees are based at least in part on acceptance costs.

6. The apparatus of claim 1 wherein the first and second net fees are based at least in part on network fees.

7. One or more non-transitory computer-readable media storing computer-executable instructions which, when executed by a processor on a computer system, perform a method for routing transaction information, the method comprising:
receiving the transaction information;
retrieving from computer readable memory a transaction information routing rule;
retrieving from the computer readable memory transaction service provider information; and
formulating routing information based on the transaction information, the transaction service provider information and the routing rule; and
if the transaction information routing rule does not identify an aquirer based on the transaction service provider information, using a transmitter to transmit a query to a network requesting identification of an aquirer to complete the transaction.

8. The media of claim 7 wherein, in the method, the formulating comprises:
determining from the transaction service provider information that an acquirer is an issuer; and,
based on the determining, applying a routing rule that requires routing the transaction information within the acquirer from an acquiring function to an issuing function.

9. The media of claim 7 wherein, in the method, the formulating comprises:
determining from the transaction service provider information that an acquirer and an issuer are members of a lending consortium; and,
based on the determining, applying a routing rule that requires routing the transaction information from the acquirer to the issuer while bypassing a transaction processing network.

10. The media of claim 7 wherein, in the method:
the determining a first net fee is based at least in part on a first interchange fee; and
the determining a second net fee is based at least in part on a second interchange fee.

11. The media of claim 7 wherein, in the method:
the determining a first net fee is based at least in part on a first acquirer acceptance cost; and
the determining a second net fee is based at least in part on a second acquirer acceptance cost.

12. The media of claim 7 wherein, in the method:
the determining a first net fee is based at least in part on a first network fee; and
the determining a second net fee is based at least in part on a second network fee.

13. A method for routing transaction information, the method comprising:
receiving, the transaction information;
retrieving, by a computer processor and a database engine, from computer readable memory:
a transaction information routing rule; and
transaction service provider information; and,
formulating, by the computer processor, routing information based on the transaction information, the transaction service provider information and the routing rule and
if the transaction information routing rule does not identify an aquirer based on the transaction service provider information, transmitting, using a transmitter, a query to a network requesting identification of an aquirer to complete the transaction.

14. The method of claim 13 wherein the formulating comprises:
determining from the transaction service provider information that an acquirer is an issuer; and,
based on the determining, applying a routing rule that requires routing the transaction information within the acquirer from an acquiring function to an issuing function.

15. The method of claim 13 wherein the formulating comprises:
determining from the transaction service provider information that an acquirer and an issuer are members of a lending consortium; and,
based on the determining, applying a routing rule that requires routing the transaction information from the acquirer to the issuer while bypassing a transaction processing network.

16. The method of claim 13 wherein:
the determining a first net fee is based at least in part on a first interchange fee; and
the determining a second net fee is based at least in part on a second interchange fee.

17. The method of claim 13 wherein:
the determining a first net fee is based at least in part on a first acquirer acceptance cost; and
the determining a second net fee is based at least in part on a second acquirer acceptance cost.

18. The method of claim 13 wherein:
the determining a first net fee is based at least in part on a first network fee; and
the determining a second net fee is based at least in part on a second network fee.
